(19) United States
(12) Patent Application Publication
(10) Pub. No.: US 2026/0238369 A1
(43) Pub. Date: Aug. 13, 2026

(54) WD AND NETWORK NODE SUPPORTING NARROW CHANNEL BANDWIDTH AND METHOD OF OPERATION THEREOF

(71) Applicant: Telefonaktiebolaget LM Ericsson (publ), Stockholm (SE)

(72) Inventors: Gerardo Agni MEDINA ACOSTA, Märsta (SE); Kittipong KITTICHOKECHAI, Järfälla (SE); Mirza Uzair BAIG, Märsta (SE); Dominique EVERAERE, Åkersberga (SE); Kazuyoshi UESAKA, Kawasaki (JP)

(21) Appl. No.: 19/155,442

(22) PCT Filed: Feb. 14, 2024
(86) PCT No.: PCT/SE2024/050134

§ 371 Date: Aug. 11, 2025

Related U.S. Application Data
(60) Provisional application No. 63/446,211, filed on Feb. 16, 2023.

(51) Int. Cl. H04J 11/00; H04L 1/00; H04W 8/22; H04W 56/00

(52) U.S. Cl. CPC H04J 11/0069; H04L 1/0068; H04W 8/22; H04W 56/0015

(57) ABSTRACT

A method and apparatus are disclosed. A network node in a wireless communication network supporting both spectrums associated with channel bandwidth less than 5 MHz and above 5 MHz, transmitting synchronization signaling based on synchronization rasters respectively associated with coexisting spectrum. The synchronization rasters associated with different bandwidth are non-overlapping. Wireless devices supporting bandwidth less than 5 MHz can receive SSBs based on the raster associated with the narrower bandwidth.

### TECHNICAL FIELD

The present disclosure relates to wireless communications, and in particular, to wireless devices (WD) and network nodes supporting narrow channel bandwidth and methods of operation thereof.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. The 3GPP is also developing standards for Sixth Generation (6G) wireless communication networks.

At RAN #94-e, a new Work Item (WI) on “NR support for dedicated spectrum less than 5 MHz for FR1” was approved.

TABLE 1
WID's justification extract from RP-213603

The Work Item Description (WID) relates to the use cases of Future Railway
Mobile Communication System (FRMCS), utilities, and public safety for which the
following has been highlighted as part of the WID's justification. Below is a WID's
justification extract from RP-213603, “NR support for dedicated spectrum less than
5 MHz for FR1,” 3GPP TSG RAN meeting #94e, Electronic Meeting, December 6-
17, 2021: “Rail Communication in Europe is used for operational purposes to
ensure the safety of millions of rail passengers. The Future Railway Mobile
Communication System (FRMCS) forms the basis for digitizing rail operations with
the aim of increasing train path utilization and improving punctuality. For the use
of the harmonized 900 MHz spectrum block (2 × 5.6 MHz FDD), for a period of
approximately 10 years from 2025 onwards, constraints stem from the need to
operate in parallel FRMCS and the currently deployed and operational GSM-R
system. Depending on the traffic volume and location, GSM-R requires a significant
portion of the 4 MHz according to the GSM-R band definition (according to
3GPP TS 45.005), although this may be expected to reduce as traffic migrates from
GSM-R to FRMCS. Consequently, possibilities in 5G NR to operate in bandwidths
<5 MHz (e.g., from around 3 MHz upwards) would enable parallel operation of
FRMCS and GSM-R and massive infrastructure reuse.
Around 1 million rail vehicles are registered in Europe. The vehicles, mostly closed
train compositions with two driving heads, which are already equipped with GSM-
R today, usually have 2 GSM-R UEs up to 6 UEs when European Train Control
System is used. This group of vehicles makes up around 10%. It may be expected
that a second group of rail vehicles (approx. 40%) will be equipped with FRMCS
capabilities during the course of the next decade. Upgrading the remaining vehicles
with FRMCS is done in a broader schedule. The responsible authorities and
organizations in Europe have set the start of the migration from GSM-R to FRMCS
for 2025.
The provision of simultaneous use of the 2 × 5.6 MHz FDD in the 900 MHz frequency
band and the associated provision of bandwidths less than 5 MHz for 5G NR thus
has a key function in order to be able to start the migration from GSM-R to FRMCS
in Europe.
In summary, FRMCS plays a key role in the automation of rail operations. It is
anticipated that this will lead to a significant improvement in route utilization and
thus also contribute to the reduction of greenhouse gases.
For Public Protection and Disaster Relief (PPDR), 2 × 3 MHz FDD in band 28 has
been identified in Europe.
NR specifications starting in Rel-15 defined a minimum bandwidth of 5 MHz
channels. Although NR can support multiple channel bandwidths due to the flexible
numerology implementation, channel bandwidths smaller than this are currently
not supported in NR. The minimum PRB size in multiples of 4 and the size of the
PBCH are the determining factors in not being able to scale to smaller than 5 MHz
channel bandwidths.”

In line with the WID's justification, the following Rel-18 objectives for RANI were defined:

TABLE 2
WID's objectives driven by RAN1 as per RP-213603

The following objectives shall be included for dedicated FDD spectrum in
FR1:

| ▪ | Identify and specify necessary changes to NR physical layer with | |
|---|---|---|
| | minimum specification impact to operate in spectrum allocations from | |
| | approximately 3 MHz up to below 5 MHz [RAN1]: | |
| | • | Restrict to subcarrier spacing of 15kHz and the use of normal cyclic |
| | | prefix. |
| | • | For SSB: |

| | |
|---|---|
| ♦ | Reuse PSS/SSS specification without puncturing. |
| ♦ | PBCH based on current design |

| | |
|---|---|
| • | Identify and specify necessary minimum changes to PDCCH, CSI- |
| | RS/TRS, PUCCH, and PRACH for functional support based on existing |
| | design, without optimization. |

The WID explicitly mentions a set of physical channels (synchronization signal block (SSB), physical downlink control channel (PDCCH), physical uplink control channel (PUCCH), and physical random access channel (PRACH)) and signals channel state information reference signal/tracking reference signal (CSI-RS/TRS) that need to be investigated as to identify and specify necessary changes on them to operate in spectrum allocations from approximately 3 MHz up to below 5 MHz.

Below is an overview of the physical channels and signals mentioned in the WID.

### SSB

Several fundamental aspects of SSB can be summarized as follows:
In existing systems, an SSB may contain the Primary Synchronization Signal (PSS), Secondary Synchronization signal (SSS), Physical Broadcast channel (PBCH) along with the Demodulation Reference Signal (DMRS).
   A Broadcast Channel (BCH) may carry the Master Information Block (MIB).
For example, in a frequency domain, one SSB block occupies 20 contiguous resource blocks which is equivalent to 240 subcarriers, e.g., as illustrated in FIG. 1. In time domain, one SSB block spans over 4 orthogonal frequency-division multiplexing (OFDM) symbols. Among the four symbols, one symbol is for PSS, one symbol is for SSS, and 2 symbols are for PBCH. Specifically, PSS occupies the first OFDM symbol of SSB and spans over 127 subcarriers. SSS is located in the third OFDM symbol of SSB and spans over 127 subcarriers. The total number of resource elements (REs) used for PBCH transmission per SSB is 576. There are, however, 113 unused subcarriers in the first symbol, and 17 unused subcarriers in the thirds symbol, as shown in the example of FIG. 1. Therefore, there are 130 unused resource elements (REs) within an SSB. In some existing NR designs, for example, the complex-valued symbols corresponding to these unused REs are set to zero. One or more SSBs may be transmitted per SS burst according with Table 3 below.
“Cell search” for “SS/PBCH block” accounting for different carrier frequencies and subcarrier spacings:
   Within one half-frame there are several occurrences of SSBs.
   The SSBs can be located in the first or second half of the frame as indicated via MIB.
   One or multiple SSBs (i.e., a group of occurrences) may compose an SS burst.
The SS burst periodicity may be, e.g., 5 ms, 10 ms, 20 ms, 40 ms, 80 ms, or 160 ms.

TABLE 3
Max number of SSBs per SS burst depending
on SCS and carrier frequency.

| | | Maximum number of SSBs per SS burst | | |
|---|---|---|---|---|
| | SCS (kHz) | f_{c} < 3 GHz | 3 GHz ≤ f_{c} ≤ 6 GHz | 6 GHz < f_{c} |
| Case A | 15 | 4 | 8 | |
| Case B | 30 | 4 | 8 | |
| Case C | 30 | 4 | 8 | |
| Case D | 120 | | | 64 |
| Case E | 240 | | | 64 |

The time-frequency structure of the SSB is depicted in the example of FIG. 1, which illustrates example Fundamentals of the time-frequency structure of the SSB.

The legacy NR SSB structure using a subcarrier spacing (SCS) of 15 kHz results in ~3.6 MHz occupancy in the frequency-domain, hence either applying a puncturing technique or a SSB structure modification may be needed for fulfilling the WID's objective.

### PDCCH

Prior to 3GPP Release 18 (Rel-18), PDCCH for NR overall may have one or more of the following characteristics:
PDCCH is mapped to a specific CORESET.
PDCCH occupies 1, 2, 4, 8, or 16 Control Channel Elements (CCEs).
   1 CCE corresponds to 6 Resource Element Groups (REGs).
      1 REG equals to 1 Resource Block (RB) in 1 OFDM symbol.
The CCE-to-REG mapping depends on a specific time-frequency resource configuration of a CORESET that spans up to 3 symbols in the time-domain.
The CCE-to-REG mapping can utilize one of the two following approaches:
   Interleaved mapping (Always applied in CORESET 0)
   Non-Interleaved mapping
      PDCCH is mapped to a specific CORESET. Thus, the highest “Aggregation level” that can be used depends on the resource blocks in the frequency domain according with

$$“ {N}_{RB}^{CORESET} ”$$

and symbols

$$“ {N}_{symb}^{CORESET} ”$$

in the time domain configured for a CORESET.

### CORESET 0

In some existing systems, in a frequency domain, a CORESET can span over one or multiple chunks of 6 RBs. For CORESETs other than CORESET 0, multiple chunks of 6 RBs can be either contiguous or non-contiguous, and the starting RB of a CORESET is determined based on clause 10.1 in 3GPP TS 38.211, “NR; Physical channels and modulation”, version 17.3.0, 3GPP Technical specifications, for example. On the other hand, CORESET 0 which is configured and used during the initial access may only have 24, 48, or 96 RBs.

For CORESET 0 configured by the ControlResourceSetZero IE:

$${N}_{RB}^{CORESET}$$

$$and$$

$${N}_{symb}^{CORESET}$$

are defined by clause 13 of [3];
the WD may assume interleaved mapping
L=6; This variable refers to the REG bundle size.
R=2; This variable refers to the Interleaver size.

$${n}_{shift} = {N}_{ID}^{cell} ;$$

the WD may assume normal cyclic prefix when CORESET 0 is configured by MIB or SIB1;
the WD may assume the same precoding being used within a REG bundle.

Moreover, CORESET 0 must be contiguous in frequency domain and only supports interleaved CCE-to-REG mapping.
REG bundle i is defined as REGs {iL, iL+1, . . . , iL+L−1} where L is the REG bundle size,

$$i = 0 , 1 , … , {N}_{REG}^{CORESET} / L - 1 ,$$

$$and$$

$${N}_{REG}^{CORESET} = {N}_{RB}^{CORESET} {N}_{symb}^{CORESET}$$

is the number of REGs in the CORESET.
For interleaved CCE-to-REG mapping,

$$L ∈ \{ 2 , 6 \}$$

$$for {N}_{symb}^{CORESET} = 1$$

$$and$$

$$L ∈ \{ {N}_{symb}^{CORESET} , 6 \}$$

$$for {N}_{symb}^{CORESET} = \{ 2 , 3 \} .$$

The interleaver is defined by

$$f ( x ) = ( rC + c + {n}_{shift} ) mod ( {N}_{REG}^{CORESET} / L )$$

$$x = cR + r$$

$$r = 0 , 1 , … , R - 1$$

$$c = 0 , 1 , … , C - 1$$

$$C = {N}_{REG}^{CORESET} / ( LR )$$

Another important aspect to consider is that there is a close connection between the location in frequency of CORESET 0 and SSB, since CORESET 0 has an offset (i.e., “Offset (RBs)”) defined with respect to “k_{ssb} offset” that in turn uses SSB as reference as illustrated in the example of FIG. 2, which is a diagram illustrating an example relationship between the location in frequency of CORESET 0 and SSB.

The puncturing on PDCCH in CORESET 0 may be determined by the puncturing applied on SSB, and the offset parameters “k_{ssb}” and “Offset (RBs)”.

### PUCCH

PUCCH in NR prior to 3GPP Rel-18 supports multiple formats (i.e., 0, 1, 2, 3, and 4), for which the frequency-domain utilization is either 1 PRB or “1 . . . 16” depending on the format. The flexibility of the PUCCH configurations in the frequency-domain suggests that in principle “spectrum allocations from approximately 3 MHz up to below 5 MHz” may be supported with no impact on PUCCH.

### PRACH

To support “spectrum allocations from approximately 3 MHz up to below 5 MHz,” if according to the WID's guideline SCS is to be 15 KHz for PRACH, then certain PRACH preamble formats, e.g., in Table 6.3.3.1-2 of TS 38.211, may apply.

Moreover, there may be a relationship between PRACH and PUSCH, e.g., as given in Table 6.3.3.2-1 of TS 38.211. If the SCS for both PRACH and PUSCH is to be 15 KHz, then in principle only one entry in Table 6.3.3.2-1 may be considered, and in that case, puncturing is not foreseen to be needed.

### CSI-RS

The Information Element (IE) CSI-FrequencyOccupation may be used to configure the frequency domain occupation of a channel state information measurement resource (e.g. NZP-CSI-RS-Resource, CSI-IM-Resource). The following descriptions may be highlighted:
nrofRBs: Number of PRBs across which this CSI resource spans. Only multiples of 4 are allowed. The smallest configurable number is the minimum of 24 and the width of the associated bandwidth part (BWP). If the configured value is larger than the width of the corresponding BWP, the WD shall assume that the actual CSI-RS bandwidth is equal to the width of the BWP.
startingRB: PRB where this CSI resource starts in relation to common resource block #0 (CRB #0) on the common resource block grid. Only multiples of 4 are allowed (0, 4, . . . ).

For CSI-RS/TRS, no puncturing is foreseen to be needed. Depending on the decisions to be taken in RAN4 on how many RBs will compose a bandwidth that “is less than 5 MHz,” the “CSI-FrequencyOccupation” can be updated accordingly to maintain the same degree of flexibility. This topic has not been discussed yet in 3GPP

### Synchronization Raster

In NR, the synchronization raster indicates the frequency positions of the synchronization signal block (SSB) that can be used by the WD to access to the cell, including time/frequency synchronization to the network and system information acquisition from the network, when explicit signaling of the synchronization signal block position, e.g., dl-CarrierFreq, is not present. The global synchronization raster is defined with corresponding Global Synchronization Channel Number (GSCN). Details of NR global synchronization frequency raster can be found in Section 5.4.3 in TS 38.104 in Rel-17 and is provided below for convenience:

TABLE 5.4.3.1-1
GSCN parameters for the global frequency raster

| Range of | SS block | | |
|---|---|---|---|
| frequencies | frequency | | Range of |
| (MHz) | position SS_{REF} | GSCN | GSCN |
| 0-3000 | N * 1200 kHz + | 3N + | 2-7498 |
| | M * 50 kHz, | (M − 3)/2 | |
| | N = 1:2499, M ∈ | | |
| | {1, 3, 5} (Note) | | |
| 3000-24250 | 3000 MHz + | 7499 + N | 7499-22255 |
| | N * 1.44 MHz, | | |
| | N = 0:14756 | | |
| 24250-100000 | 24250.08 MHz + | 22256 + N | 22256-26639 |
| | N * 17.28 MHz, | | |
| | N = 0:4383 | | |

(Note):
The default value for operating bands which only support SCS spaced channel raster(s) is M = 3.

For example, for frequency bands whose centre frequency is less than 3 GHZ and support only SCS spaced channel raster, the synchronization raster is specified every 1200 kHz (1.2 MHz).

For each operating band, the synchronization raster entries are given through the applicable GSCN entries defining possible RF positions for SSB. For example, for FR1, the applicable NR-ARFCN are specified in table 5.4.3.3-1 in TS 38.104. The synchronization raster and the subcarrier spacing of the synchronization signal block is defined separately for each band.

In 3GPP Rel-17, RAN4 has specified synchronization raster entries for NR band n100 based on the minimum guard band specified for the minimum supported channel band for that band, which is 5 MHz channel bandwidth. The specified synchronization raster entries for NR band n100 correspond to
Range of GSCN: 2303-<1>-2307

The above range is obtained based on N=768 and 769 with M=1,3,5, which correspond to SS_{REF}=921650, 921750, 921850, 922850, 922950 kHz. Note that there may be only 5 possible SSB frequency position within NR band n100.

Note that synchronization raster maps to subcarrier number 120 of the SSB. That is, SS_{REF} is located on the first subcarrier of the resource block (RB) number 10 of the SSB block (which corresponds to the 11^{th} RB of the SSB block). FIG. 3 is a diagram illustrating an example frequency position of the synchronization raster within an SSB.

### Time Domain Pattern of Candidate SSB Transmission/Reception

In NR, a time domain pattern of candidate SSB transmission/reception is used to determine first symbol indexes for candidate SSBs within a half frame. There exist different cases with different details for time domain pattern of candidate SSB transmission/reception depending on SSB SCS, carrier frequency, whether it is for operation without shared spectrum channel access, and whether it is for FDD or TDD operation.

For the frequency bands of interest in 3GPP Rel-18 work item on “NR support for dedicated spectrum less than 5 MHz for FR1”, time domain pattern Case A for operation without shared spectrum channel access and for carrier frequencies smaller than or equal to 3 GHz is applicable. The following details of relevant time domain pattern are taken from TS 38.213 Rel-17, Clause 4.1:

For a half frame with SS/PBCH blocks, the first symbol indexes for candidate
SS/PBCH blocks are determined according to the SCS of SS/PBCH blocks as
follows, where index 0 corresponds to the first symbol of the first slot in a half-
frame.

| - | Case A - 15 kHz SCS: the first symbols of the candidate SS/PBCH blocks | |
|---|---|---|
| | have indexes of {2,8}+14·n. | |
| | - | For operation without shared spectrum channel access: |

| | |
|---|---|
| - | For carrier frequencies smaller than or equal to 3 GHz, |
| | n=0,1. |

### Cell Barring

In NR, a cell can be “barred” so that a WD meeting the “barring” condition is not allowed to camp on the cell. Information related to cell barring is included in MIB and SIB 1 through a field cellBarred. The cellBarred field in MIB can be set to value ‘barred’ or ‘notBarred’. The field is ignored by IAB-MT as well as for WD supporting NTN. More description related to the cellBarred field in MIB and SIB1 can be found in 3GPP TS 38.331. Another field is the intraFrequencyReselection field in the MIB which can take value ‘allowed’ and ‘notAllowed’ and it indicates whether access is permitted to other cells on the same frequency given than the cellBarred field has value ‘barred’.

Although MIB-based cell barring is applicable for any WDs camping on to the cell, SIB1-based barring can target specific WDs.

One example of cell barring is for reduced capability (RedCap) WD with 1Rx (cellBarredRedCap1Rx) and/or 2Rx (cellBarredRedCap2Rx). If the operator does not want the RedCap 1Rx WD to connect to a cell, the network node (e.g., gNB) sets the cellBarredRedCap1Rx to ‘barred’ in SIB1. When the RedCap 1Rx WD read this information, it considers this cell is barred and then performs the cell re-selection procedure to other cells until it finds a cell which does not bar the RedCap 1Rx WD.

Another example of cell barring is to allow only an operator's users to access to the cell. This barring can be achieved by setting the parameter cellReservedForOtherUse to ‘reserved’ in SIB1.

In some legacy NR systems, the minimum support channel bandwidth (BW) for FR1 operation is 5 MHz. In Rel-18, the work item “NR support for dedicated spectrum less than 5 MHz for FR1” was introduced to support NR operation with channel BW of less than 5 MHz for some specific NR frequency bands, namely bands n8, n26, n28, and n100.

### SUMMARY

It can be envisioned that for these frequency bands with channel BW of less than 5 MHz, there may exist new WDs supporting only the new sync-raster design (with finer granularity) or both the new and legacy sync-raster designs while they support channel BWs of 5 MHz and less than 5 MHz (e.g., 3 MHz). This may result in ambiguity at the network side (e.g., at a network node, such as a base station, in communication with a WD) and at the WD side (e.g., a UE) if for example a new WD that only supports the new sync-raster design tries to access a legacy network supporting only the legacy initial access procedures. In summary, there may be at least 3 possible scenarios:
A new WD (e.g. type 1), supporting channel BW of less than 5 MHz and supporting only new sync raster designed for bands supporting less than 5 MHz as minimum channel bandwidth, accesses to the cell operating with channel BW of less than 5 MHz.
A new WD (e.g. type 2), supporting channel BW of less than 5 MHz and supporting both legacy and new sync raster designed for bands supporting less than 5 MHz as minimum channel bandwidth, accesses to the cell operating with channel BW of less than 5 MHz.
A legacy WD, not supporting channel BW of less than 5 MHz and then not supporting the new sync raster, accesses to the cell operating with channel BW of less than 5 MHz.

Solutions are needed to ensure good coexistence between legacy WDs and new WD supporting channel BW of less than 5 MHz operating in these bands.

Moreover, if there is a WD supporting both 5 MHz channel BW and channel BW of less than 5 MHz, the behavior of this type of WD when performing initial access, e.g., receiving SSB, is also unclear.

Thus, existing systems lack configurations for supporting coexistence of legacy WDs and new WDs supporting channel bandwidths of less than 5 MHz.

In this disclosure, some embodiments advantageously provide methods, systems, and apparatuses for configurations for supporting coexistence of legacy WDs and new WDs supporting channel bandwidths of less than 5 MHz.

The present disclosure proposes solutions to enable good coexistence between legacy WDs, which support channel BW of 5 MHz or more, i.e., supported minimum channel BW is 5 MHz, and new WDs supporting channel BW of less than 5 MHz and possibly more operating in frequency bands supporting channel BW of less than 5 MHz (e.g., 3 MHz).

In some embodiments, solutions are provided related to new sync raster designed to support channel BWs of less than 5 MHz and related WD behavior when receiving SSB on the new sync raster entries.

In some embodiments, solutions are provided related to clarifying the WD behavior when receiving SSB in a cell supporting both 5 MHz channel BW and channel BW of less than 5 MHz if the WD is capable of supporting both 5 MHz channel BW and channel BWs of less than 5 MHz.

In some embodiments, solutions are provided which prevent legacy WDs from accessing the cell supporting channel BWs of less than 5 MHz.

For example, embodiments of the present disclosure may provide one or more of the following:
Example 1. Methods for WD supporting and/or being configured with a channel BW of less than 5 MHz to receive SSB in a cell (e.g., from a network node, such as gNB) supporting both 5 MHz channel BW and channel BW of less than 5 MHz;
Example 2. Based on Example 1, the WD may be configured to receive SSB (e.g., from a network node) on new sync raster entry which is non-overlapping with legacy sync raster entry;
Example 3. Based on Examples 1 and 2, the WD may be configured to receive SSB (e.g., from a network node) on new sync raster entry which is non-overlapping with legacy sync raster entry where the non-overlapping sync raster entries can be determined by applying an offset to the overlapping sync raster entries.
Example 4. Based on Examples 1 and 2, the WD may be configured to receive SSB (e.g., from a network node) on new sync raster entry which is non-overlapping by ignoring the sync raster entries which overlap with the legacy sync raster entries.
Example 5. Based on Example 1, when the WD supports both 5 MHz channel BW and channel BW of less than 5 MHz, the WD may be configured to receive the SSB (e.g., from a network node) only on legacy sync raster entries.
Example 6. Based on Example 1, when the WD supports both 5 MHz channel BW and channel BW of less than 5 MHz, the WD may be configured to receive the SSB (e.g., from a network node) on both legacy sync raster entries and the new sync raster entries for channel BW of less than 5 MHz.
Example 7. Based on Example 1, WD supporting channel BW of less than 5 MHz when accessing a cell may be configured to ignore the cell barring information in MIB, i.e., the WD ignore the field ‘cellBarred’ in MIB, as received from a network node.

In any of the above examples, the WD may be configured based on configuration information received from a network node, and/or based on preconfigured configuration information, e.g., stored in WD memory.

Embodiments of the present disclosure may advantageously improve coexistence between legacy WDs and new WDs supporting channel BW of less than 5 MHz to operate in the same cell and/or frequency band, e.g., as compared to existing systems.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a diagram illustrating an example time-frequency structure of an SSB;

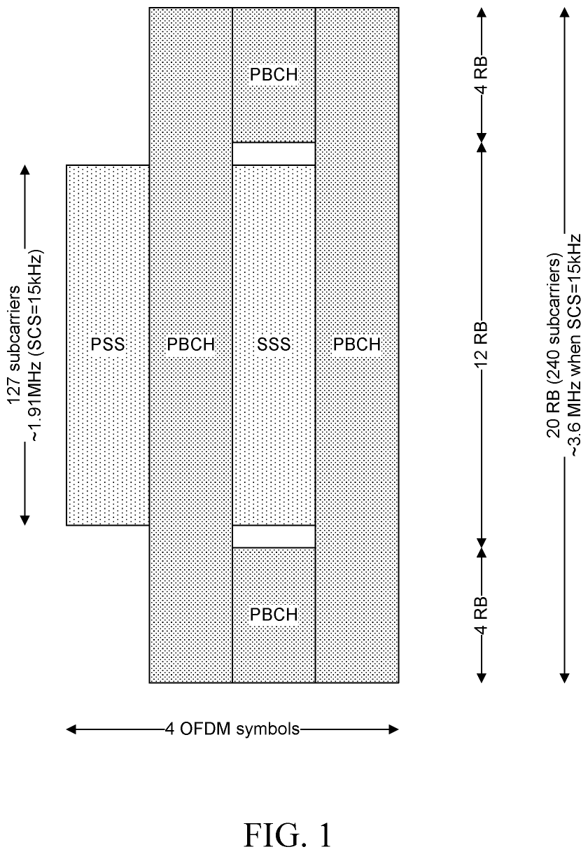

FIG. 2 is a diagram illustrating an example relationship between the location in frequency of CORESET 0 and SSB;

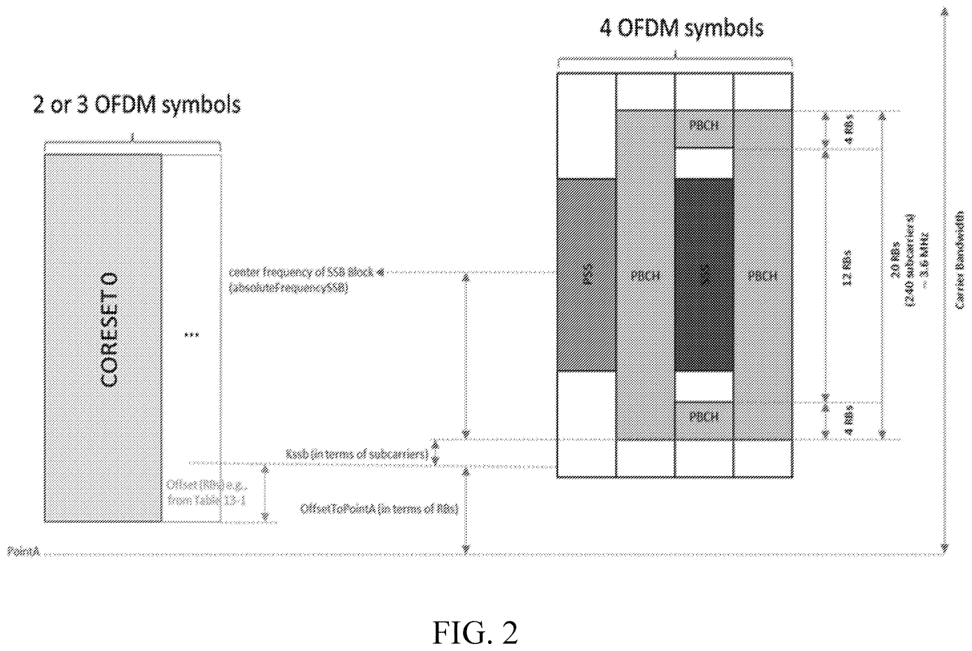

FIG. 3 is a diagram illustrating an example frequency position of the synchronization raster within an SSB;

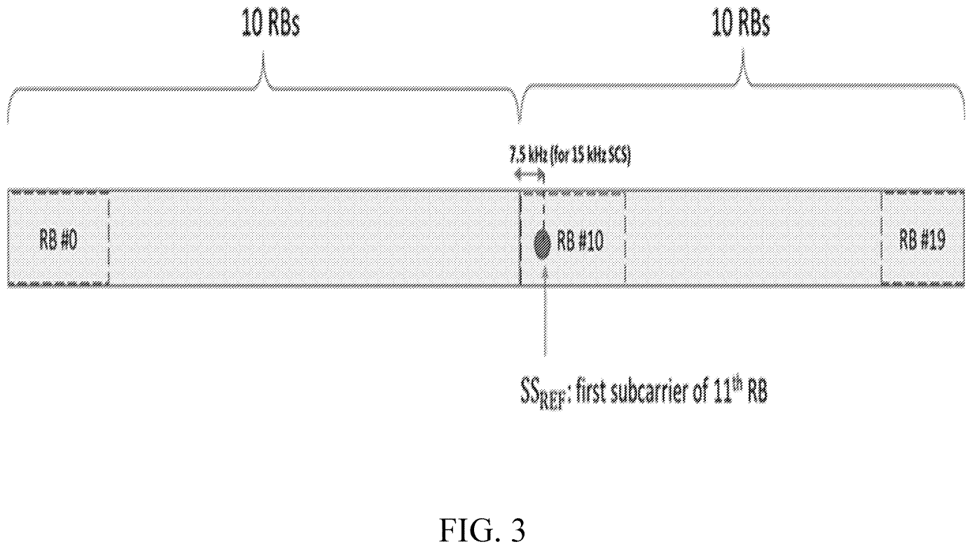

FIG. 4 is a schematic diagram of an example network architecture illustrating a communication system according to principles disclosed herein;

FIG. 5 is a block diagram of a network node in communication with a wireless device over a wireless connection according to some embodiments of the present disclosure;

FIG. 6 is a flowchart of an example process in a network node for supporting coexistence of legacy WDs and new WDs supporting channel bandwidth of less than 5 MHz according to some embodiments of the present disclosure;

FIG. 7 is a flowchart of an example process in a wireless device for supporting coexistence of legacy WDs and new WDs supporting channel bandwidth of less than 5 MHz according to some embodiments of the present disclosure;

FIG. 8 is a diagram illustrating an example sync raster configuration according to embodiments of the present disclosure;

FIG. 9 is a diagram illustrating an example sync raster configuration according to some embodiments of the present disclosure; and

FIG. 10 is a diagram illustrating an example sync raster configuration according to some embodiments of the present disclosure.

### DETAILED DESCRIPTION

Before describing in detail exemplary embodiments, it is noted that the embodiments reside primarily in combinations of apparatus components and processing steps related to configurations for supporting coexistence of legacy WDs and new WDs supporting channel bandwidth of less than 5 MHz. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, RedCap device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments are directed to configurations for supporting coexistence of legacy WDs and new WDs supporting channel bandwidth of less than 5 MHz.

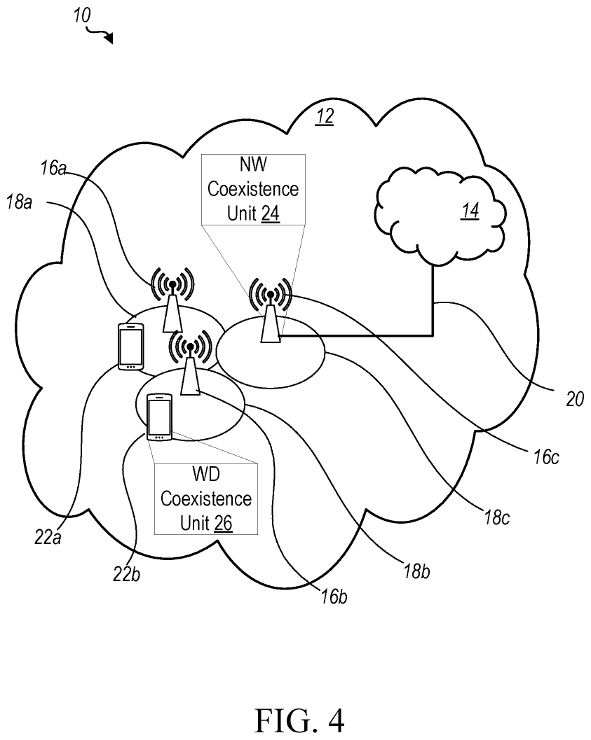

Referring again to the drawing figures, in which like elements are referred to by like reference numerals, there is shown in FIG. 4 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

A network node 16 (eNB or gNB) is configured to include a NW Coexistence unit 24 which is configured for supporting coexistence of legacy WDs and new WDs supporting channel bandwidth of less than 5 MHz. A wireless device 22 is configured to include a WD Coexistence unit 26 which is configured for supporting coexistence of legacy WDs 22 and new WDs 22 supporting channel bandwidth of less than 5 MHz.

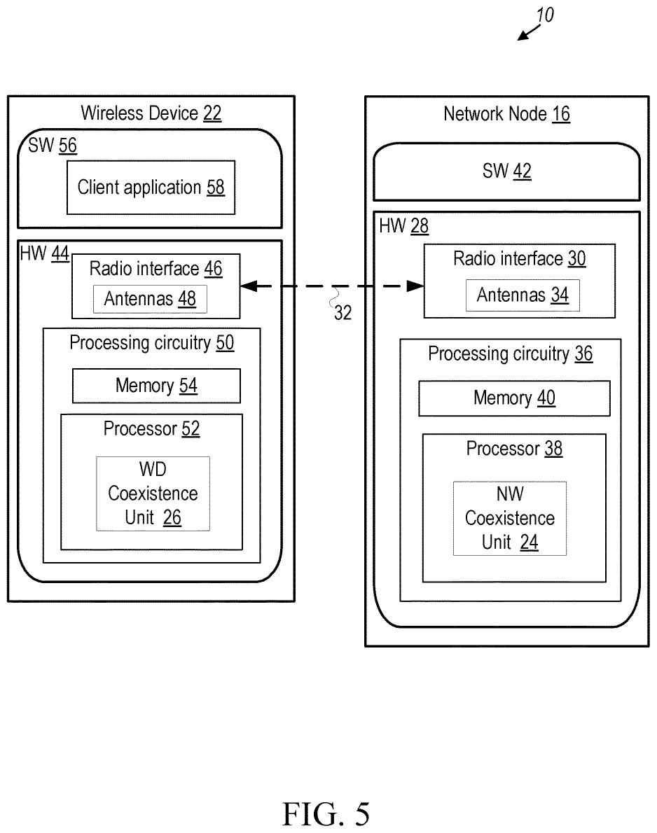

Example implementations, in accordance with an embodiment, of the WD 22 and network node 16 discussed in the preceding paragraphs will now be described with reference to FIG. 5.

The communication system 10 includes a network node 16 provided in a communication system 10 and including hardware 28 enabling it to communicate with the WD 22. The hardware 28 may include a radio interface 30 for setting up and maintaining at least a wireless connection 32 with a WD 22 located in a coverage area 18 served by the network node 16. The radio interface 30 may be formed as or may include, for example, one or more RF transmitters, one or more RF receivers, and/or one or more RF transceivers. The radio interface 30 includes an array of antennas 34 to radiate and receive signal(s) carrying electromagnetic waves.

In the embodiment shown, the hardware 28 of the network node 16 further includes processing circuitry 36. The processing circuitry 36 may include a processor 38 and a memory 40. In particular, in addition to or instead of a processor, such as a central processing unit, and memory, the processing circuitry 36 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 38 may be configured to access (e.g., write to and/or read from) the memory 40, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 42 stored internally in, for example, memory 40, or stored in external memory (e.g., database, storage array, network storage device, etc.) accessible by the network node 16 via an external connection. The software 42 may be executable by the processing circuitry 36. The processing circuitry 36 may be configured to control any of the methods and/or processes described herein and/or to cause such methods, and/or processes to be performed, e.g., by network node 16. Processor 38 corresponds to one or more processors 38 for performing network node 16 functions described herein. The memory 40 is configured to store data, programmatic software code and/or other information described herein. In some embodiments, the software 42 may include instructions that, when executed by the processor 38 and/or processing circuitry 36, causes the processor 38 and/or processing circuitry 36 to perform the processes described herein with respect to network node 16. For example, processing circuitry 36 of the network node 16 may include NW Coexistence unit 24 which is configured for supporting coexistence of legacy WDs 22 and new WDs 22 supporting channel bandwidth of less than 5 MHz.

The communication system 10 further includes the WD 22 already referred to. The WD 22 may have hardware 44 that may include a radio interface 46 configured to set up and maintain a wireless connection 32 with a network node 16 serving a coverage area 18 in which the WD 22 is currently located. The radio interface 46 may be formed as or may include, for example, one or more RF transmitters, one or more RF receivers, and/or one or more RF transceivers. The radio interface 46 includes an array of antennas 48 to radiate and receive signal(s) carrying electromagnetic waves.

The hardware 44 of the WD 22 further includes processing circuitry 50. The processing circuitry 50 may include a processor 52 and memory 54. In particular, in addition to or instead of a processor, such as a central processing unit, and memory, the processing circuitry 50 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 52 may be configured to access (e.g., write to and/or read from) memory 54, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 56, which is stored in, for example, memory 54 at the WD 22, or stored in external memory (e.g., database, storage array, network storage device, etc.) accessible by the WD 22. The software 56 may be executable by the processing circuitry 50. The software 56 may include a client application 58. The client application 58 may be operable to provide a service to a human or non-human user via the WD 22.

The processing circuitry 50 may be configured to control any of the methods and/or processes described herein and/or to cause such methods, and/or processes to be performed, e.g., by WD 22. The processor 52 corresponds to one or more processors 52 for performing WD 22 functions described herein. The WD 22 includes memory 54 that is configured to store data, programmatic software code and/or other information described herein. In some embodiments, the software 56 and/or the client application 58 may include instructions that, when executed by the processor 52 and/or processing circuitry 50, causes the processor 52 and/or processing circuitry 50 to perform the processes described herein with respect to WD 22. For example, the processing circuitry 50 of the wireless device 22 may include WD Coexistence unit 26 which is configured for supporting coexistence of legacy WDs 22 and new WDs 22 supporting channel bandwidth of less than 5 MHz.

In some embodiments, the inner workings of the network node 16 and WD 22 may be as shown in FIG. 5 and independently, the surrounding network topology may be that of FIG. 4.

The wireless connection 32 between the WD 22 and the network node 16 is in accordance with the teachings of the embodiments described throughout this disclosure. More precisely, the teachings of some of these embodiments may improve the data rate, latency, and/or power consumption and thereby provide benefits such as reduced user waiting time, relaxed restriction on file size, better responsiveness, extended battery lifetime, etc. In some embodiments, a measurement procedure may be provided for the purpose of monitoring data rate, latency and other factors on which the one or more embodiments improve.

Although FIGS. 4 and 5 show various “units” such as NW Coexistence unit 24 and WD Coexistence unit 26 as being within a respective processor, it is contemplated that these units may be implemented such that a portion of the unit is stored in a corresponding memory within the processing circuitry. In other words, the units may be implemented in hardware or in a combination of hardware and software within the processing circuitry.

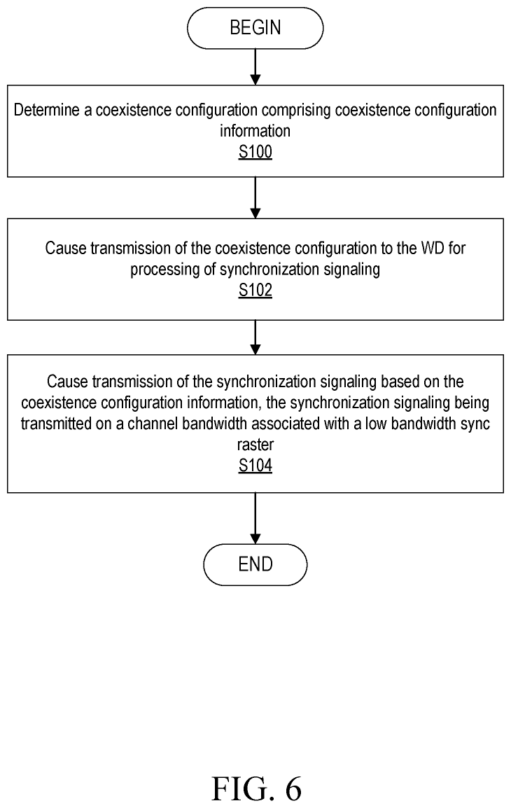

FIG. 6 is a flowchart of an example process in a network node 16 for supporting coexistence of legacy WDs and new WDs supporting channel bandwidth of less than 5 MHz. One or more blocks described herein may be performed by one or more elements of network node 16 such as by one or more of processing circuitry 36 (including the NW Coexistence unit 24), processor 38, and/or radio interface 30. Network node 16 is configured to determine (Block S100) a coexistence configuration comprising coexistence configuration information. Network node 16 is configured to transmit (Block S102) the coexistence configuration to the WD 22 for processing of synchronization signaling (e.g., SSB signaling). Network node 16 is configured to transmit (Block S104) the synchronization signaling (e.g., to WD 22) based on the coexistence configuration information, the synchronization signaling being transmitted on a channel bandwidth associated with a low bandwidth sync raster. As used herein, a low bandwidth sync raster is a sync raster used with channels having a bandwidth lower than those used with a channel bandwidth associated with a high bandwidth sync raster.

In some embodiments, the high bandwidth sync raster is associated with bandwidths at or above 5 MHz, and the low bandwidth sync raster is associated with bandwidths below 5 MHz. In some embodiments, the low bandwidth sync raster is overlapping with a legacy sync raster, and the network node 16 is further configured to determine a frequency offset to the overlapping sync raster entries based on the coexistence configuration information, and cause transmission and/or configure the synchronization signaling by applying the frequency offset to the legacy sync raster.

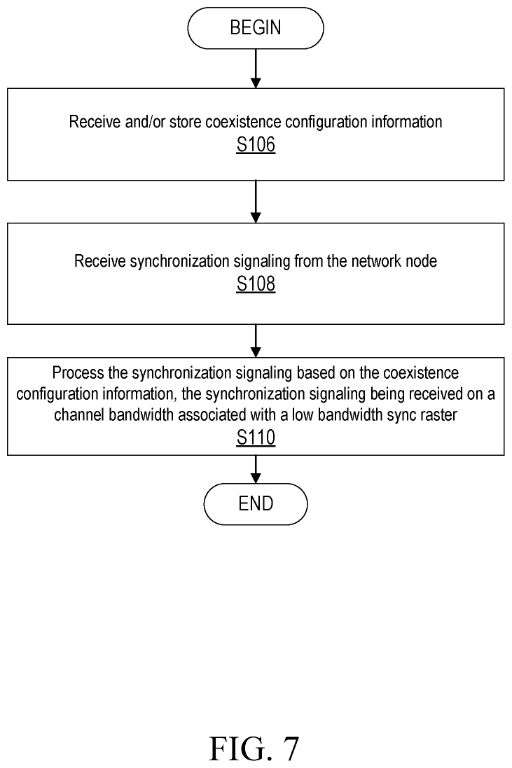

FIG. 7 is a flowchart of an example process in a wireless device 22 according to some embodiments of the present disclosure. One or more blocks described herein may be performed by one or more elements of wireless device 22 such as by one or more of processing circuitry 50 (including the WD Coexistence unit 26), processor 52, and/or radio interface 46. Wireless device 22 is configured to receive (e.g., from network node 16) and/or store (Block S106) coexistence configuration information. Wireless device 22 is configured to receive (Block S108) synchronization signaling from the network node 16. Wireless device 22 is configured to process (Block S110) (e.g., identify/determine one or more resource elements, blocks, etc., for locating and/or decoding and/or other processing of synchronization signaling, such as SSB signaling) the synchronization signaling based on the coexistence configuration information, where the synchronization signaling is received on a channel bandwidth associated with a low bandwidth sync raster.

In some embodiments, the high bandwidth sync raster is associated with bandwidths at or above 5 MHz, and the low bandwidth sync raster is associated with bandwidths below 5 MHz. In some embodiments, the low bandwidth sync raster is overlapping with a legacy sync raster, and the WD 22 is further configured to determine a frequency offset to the overlapping sync raster entries based on the coexistence configuration information, and process the synchronization signaling by applying the frequency offset to the legacy sync raster.

Having described the general process flow of arrangements of the disclosure and having provided examples of hardware and software arrangements for implementing the processes and functions of the disclosure, the sections below provide details and examples of arrangements for supporting coexistence of legacy WDs and new WDs supporting channel bandwidth of less than 5 MHz.

Some embodiments provide configurations for supporting coexistence of legacy WDs and new WDs supporting channel bandwidth of less than 5 MHz.

The embodiments below cover methods to ensure good coexistence between legacy WD 22s and new WD 22s supporting channel BW of less than 5 MHz, e.g., 3 MHz when the WD 22s are operating in certain FDD bands in FR1 with 15 kHz SCS. The embodiments are applicable to any NR frequency bands supporting channel BW of less than 5 MHz, including bands n8, n26, n28, and n100. The term “legacy WD 22” or “legacy UE 22” refers to a WD 22 supporting 5 MHz as the minimum supported channel BW. The term “new WD 22” or “new UE 22” refers to a WD 22 supporting less than 5 MHz as the minimum supported channel BW. The term “legacy sync raster” may refer to a sync raster designed for bands supporting 5 MHz (or wider) as minimum channel bandwidth. The term “new sync raster” may refer to a sync raster designed for bands supporting less than 5 MHz as minimum channel bandwidth.

Furthermore, although the present disclosure describes examples of NR systems in which legacy sync raster has a minimum bandwidth of 5 MHz and new sync raster has a maximum bandwidth of 5 MHz, i.e., the legacy sync raster(s) and new sync raster(s) are separated by a 5 MHz threshold, the principles of the present disclosure may be applied to other systems in which legacy sync raster(s) and new sync raster(s) are separated by a different frequency threshold value other than 5 MHz.

Example frequency band numbers and their frequency range may be defined as follows in the specification [TS 38.104] (other bands and ranges may be used without deviating from the scope of the present disclosure):

| NR operating | Uplink | Downlink | Duplex |
|---|---|---|---|
| band | frequency range | frequency range | mode |
| n8 | 880 MHz-915 MHz | 925 MHz-960 MHz | FDD |
| n26 | 814 MHz-849 MHz | 859 MHz-894 MHz | FDD |
| n28 | 703 MHz-748 MHz | 758 MHz-803 MHz | FDD |
| n100 | 874.4 MHz-880 MHz | 919.4 MHz-925 MHz | FDD |

a New Sync Raster Design and Corresponding WD 22 Behavior when Receiving SSB on the New Sync Raster

In some NR systems, new sync raster entries are expected to be introduced for the frequency bands supporting channel BW of less than 5 MHz, e.g., 3 MHz. The new sync raster entries may have different step sizes/granularities compared to the legacy sync raster entries of the bands (e.g., raster step size is 1.2 MHz for frequency bands whose transmission frequency is less than 3 GHz). To ensure good coexistence between legacy WD 22s and new WD 22s in the frequency bands of interest, it may be desirable and/or advantageous to design the new sync raster so that both the new and legacy WD 22 behaviors when accessing the network node 16 are clearly defined and/or predictable (e.g., based on coexistence configuration information received from a network node 16 and/or preconfigured in memory 54). One benefit of having such clear (and/or predictable) WD 22 behavior is that new WD 22s when detecting SSB on a new sync raster entry may assume (e.g., may be configured to assume based on coexistence configuration information received from a network node 16 and/or preconfigured in memory 54) that SSB is transmitted in a predefined and non-ambiguous manner, e.g., that SSB is punctured and only a subset of PRBs is used for the SSB transmission.

In some embodiments, to ensure good (e.g., improved over existing systems, satisfying one or more performance requirements, etc.) coexistence between legacy WD 22s and new WD 22s in the frequency bands of interest with respect to initial cell search/initial access procedure, in some embodiments, the WD 22 (e.g., based on coexistence configuration information received from a network node 16 and/or preconfigured in memory 54) and/or network node 16 (e.g., based on coexistence configuration information received from a WD 22, from another network node 16, stored in memory 40, etc.) rely on the distinction of legacy and new sync raster entries. With the clear distinction, when performing the initial cell search/initial access procedure, the legacy WD 22s can attempt to detect SSB only on the legacy sync raster entries, while the new WD 22s can attempt to detect SSB for channel BW of less than 5 MHz, e.g., 3 MHz, only on the new sync raster entries.

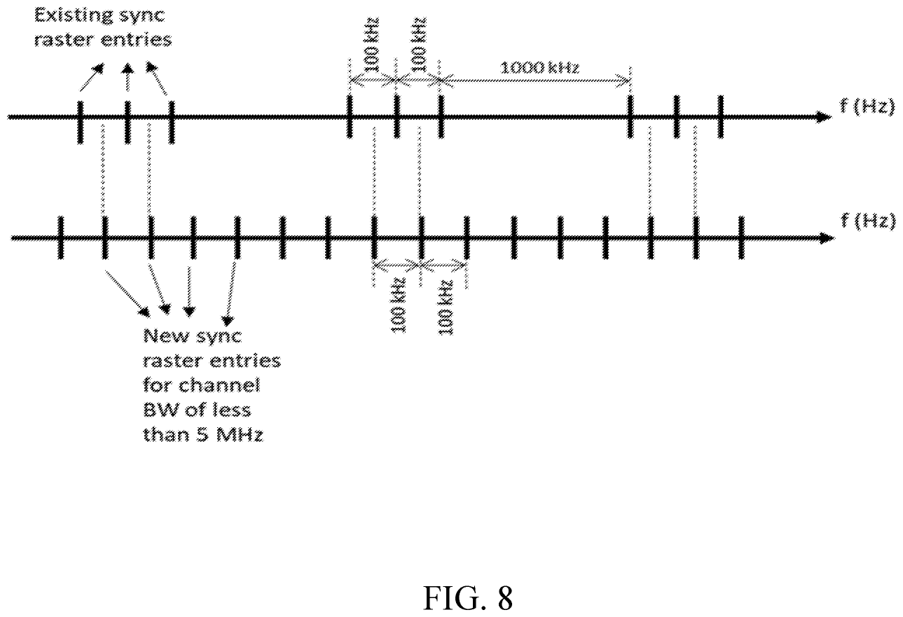

In some embodiments, the new sync raster entries are introduced in such a way that they are not overlapping with any of the existing (i.e., legacy) sync raster entries in a band. FIG. 8 illustrates an example sync raster configuration according to embodiments of the present disclosure.

In FIG. 8, new sync raster entries with raster step size of 100 kHz are illustrated. The new sync raster entries in this example are not overlapping with any of the existing sync raster entries in a band.

### New WD 22 (Type 1) Supporting Only the New Sync Raster

In some embodiments and/or systems, new sync raster entries for the band of interest results in some entries may be overlapping with the existing sync raster entries, in which case, various techniques described herein may be applied to ensure clear (e.g., defined, predictable, etc.) WD 22 behavior (e.g., based on coexistence configuration information received from a network node 16 and/or preconfigured in memory 54) when accessing the network node 16, e.g., on the overlapping sync raster entries.

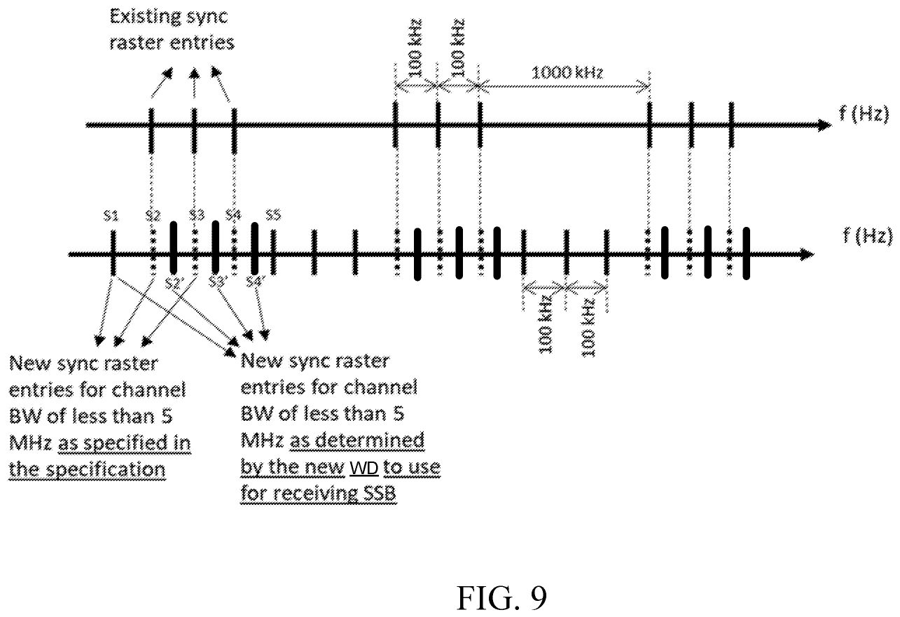

In some embodiments, if a new sync raster entry overlaps with a legacy sync raster entry, a new WD 22 determines (e.g., based on coexistence configuration information received from a network node 16 and/or preconfigured in memory 54) a new location of the new sync raster entry by applying a fixed frequency offset to the sync raster entry. In this case, the new WD 22 may be expected to receive the SSB for channel BW of less than 5 MHz, e.g., 3 MHz, on the new location of the new sync raster entry, e.g., after applying the offset. FIG. 9 illustrates an example sync raster configuration according to some embodiments of the present disclosure.

In FIG. 9, an example embodiment of new sync raster entries with raster step size of 100 kHz are depicted, where some of new sync raster entries (e.g., as specified in the specification) may overlap with the existing sync raster entries in a band. The WD 22 may determine (e.g., based on coexistence configuration information received from a network node 16 and/or preconfigured in memory 54) new locations of these new sync raster entries, e.g., by applying a fixed frequency offset. In the example of FIG. 9, because S2 overlaps with the existing sync raster entry in a band, the WD 22 determines S2′ to be a new location of the sync raster entry, e.g., by applying a frequency offset to the sync raster entry S2. In some embodiments, the frequency offset value may be preconfigured in the WD 22 (e.g., stored in memory 54), and/or may be received in an any of an indication, message, configuration, file, etc., signaled from a network node 16. The time offset can be in unit of OFDM symbols or slots, for example, or may be any other appropriate unit in the time domain (e.g., seconds, minislots, relative or absolute time, etc.).

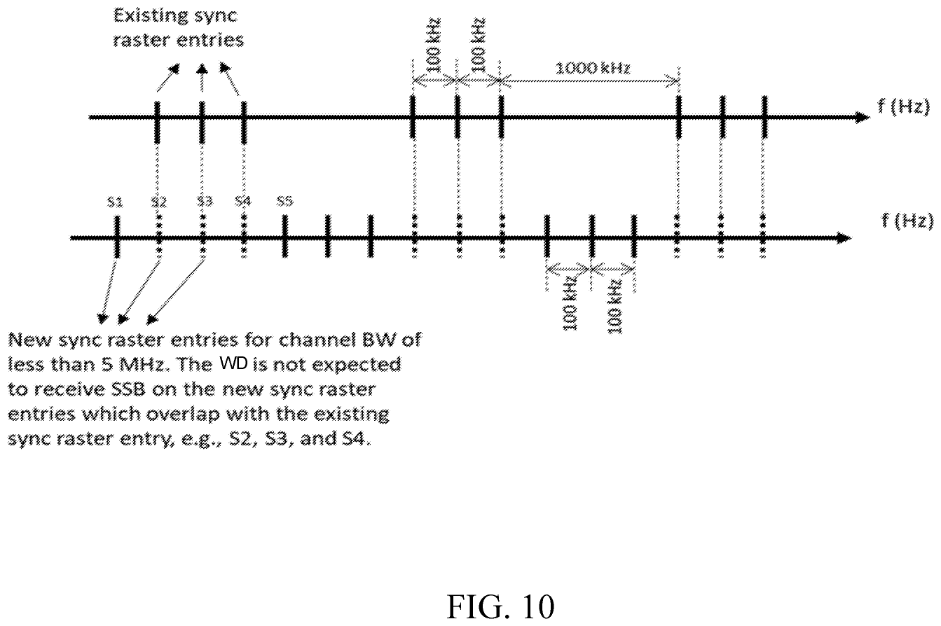

In some embodiments, if a new sync raster entry overlaps with a legacy sync raster entry, a new WD 22 may not be expected (e.g., configured based on coexistence configuration information received from a network node 16 and/or preconfigured in memory 54) to receive SSB (e.g., a punctured SSB) for channel BW of less than 5 MHz on the new sync raster entry. FIG. 10 illustrates an example sync raster configuration according to some embodiments of the present disclosure.

In FIG. 10, an example of new sync raster entries with raster step size of 100 kHz is depicted, where some of new sync raster entries may overlap with the existing sync raster entries in a band. The new WD 22 supporting channel BW of less than 5 MHz may not be expected to receive SSB for channel BW of less than 5 MHz on the new sync raster entries S2, S3, and S4, in this example.

In some embodiments, if a new sync raster entry overlaps with a legacy existing sync raster entry, a new WD 22 may be expected (e.g., configured based on coexistence configuration information received from a network node 16 and/or preconfigured in memory 54) to receive SSB on the sync raster entry, e.g., by assuming that SSB is transmitted based on the legacy SSB structure, i.e., SSB of size 20 PRBs in frequency domain. In this case, the new sync raster entry which overlaps with a legacy sync raster entry may not provide any knowledge regarding the channel BW of less than 5 MHz to the new WD 22. The new WD 22 may still obtain such information via SIB1 transmission (e.g., from one or more network nodes 16) at a later stage.

### New WD 22 (Type 2) Supporting Both the Legacy and the New Sync Raster

It is possible that the new WD 22 may also be configured to support larger channel BW, e.g., 5 MHz (e.g., in addition to supporting smaller channel BW, e.g., less than 5 MHz). When operating in a frequency band which supports both 5 MHz channel BW and channel BW of less than 5 MHz, e.g., 3 MHz, it is unclear how the new WD 22 should access the cell. For example, in some existing systems, it is unclear (e.g., the WD 22 lacks configurations for) whether it should attempt to receive an SSB only on the new sync raster for channel BW of less than 5 MHz, or to receive an SSB only on the existing (legacy) sync raster entries, or both.

In some embodiments the new WD 22 supporting both legacy and new sync raster may be expected (e.g., configured based on coexistence configuration information received from a network node 16 and/or preconfigured in memory 54) to receive SSB only on the existing (legacy) sync raster entries. When receiving SSB on the existing (legacy) sync raster entries, the new WD 22 may be expected (e.g., configured based on coexistence configuration information received from a network node 16 and/or preconfigured in memory 54) to receive SSB and corresponding PDCCH in CORESET #0 according to the legacy SSB and CORESET #0 structures, i.e., non-punctured 20-PRB SSB and CORESET #0 configuration as indicated via MIB. Information regarding channel BW or related BWPs can be obtained in SIB1 or at a later stage.

In some embodiments, the new WD 22 supporting both legacy and sync raster may be expected (e.g., configured based on coexistence configuration information received from a network node 16 and/or preconfigured in memory 54) to receive SSB only on the new sync raster entries. In this case, the new sync raster entries are also applicable to channel BW of 5 MHz. However, when receiving SSB on the new sync raster entries, the new WD 22 may be expected (e.g., configured based on coexistence configuration information received from a network node 16 and/or preconfigured in memory 54) to receive SSB according to the SSB structure specified for channel BW of less than 5 MHz, i.e., punctured 15-PRB SSB.

In some embodiments, WD 22 may obtain (e.g., from a network node 16, such as via control signaling, implicit signaling, etc.) information regarding related BWPs, e.g., in SIB1, or at a later stage where the BWP sizes can be larger than 15 PRBs. In some embodiments, the WD 22 may obtain information through a new “1-bit flag” field in MIB (e.g., from a network node 16) that indicates whether the WD 22 is operating in a channel BW of less than 5 MHz or not, this as to continue or not being confined to transmitting/receiving in a channel BW of less than 5 MHz.

In some embodiments, the new WD 22 supporting both new and legacy sync raster may be expected (e.g., configured based on coexistence configuration information received from a network node 16 and/or preconfigured in memory 54) to receive SSB on both the legacy sync raster entries and the new sync raster entries. When receiving SSB on the legacy sync raster entries, the new WD 22 may be expected (e.g., configured based on coexistence configuration information received from a network node 16 and/or preconfigured in memory 54) to receive SSB and corresponding PDCCH in CORESET #0 according to the legacy SSB and CORESET #0 structures, i.e., non-punctured 20-PRB SSB and CORESET #0 configuration as indicated via MIB.

In general, and especially in the above embodiment, when WD 22 may be expected (e.g., configured based on coexistence configuration information received from a network node 16 and/or preconfigured in memory 54) to receive SSB on both new and legacy sync raster, the SSB transmitted on the new sync raster may be in different slots and/or OFDM symbols within a slot compared to those used for legacy SSB transmission. If the same time domain pattern of candidate SSB transmission is used for both SSB transmissions on legacy and new sync raster, some restriction for SSB transmissions may be needed in the WD 22 coexistence configuration and/or network node 16 coexistence configuration.

In some embodiments, if a WD 22 may be expected (e.g., configured based on coexistence configuration information received from a network node 16 and/or preconfigured in memory 54) to receive SSB on both new and legacy sync raster, the SSB transmissions on new and legacy sync raster are not overlapped in time and/or frequency. Such restriction may be assumed and/or applied at the network node 16, for example, and may be assumed and/or applied at the WD 22.

In some embodiments, a new time domain pattern is introduced for SSB transmission on the new sync raster, e.g., as compared to a legacy sync raster.

In some embodiments, a WD 22 determines (e.g., based on coexistence configuration information received from a network node 16 and/or preconfigured in memory 54) the new time domain pattern of candidate SSB transmission on the new sync raster, e.g., by applying a fixed time offset to the legacy time domain pattern of legacy SSB such that SSB transmission on the new sync raster do not overlap with that on the legacy sync raster. The time offset can be in unit of OFDM symbols or slots, for example, or other units of time, as described herein.

In some embodiments, if WD 22 may be expected (e.g., configured based on coexistence configuration information received from a network node 16 and/or preconfigured in memory 54) to receive SSB on both new and legacy synch raster, e.g., when the SSB transmissions on new and legacy sync raster are transmitted on different SCS carriers.

Legacy WD 22 Attempting to Access to a Cell 18 Having a Channel BW of Less than 5 MHz

Some embodiments provide configurations for ensuring that there is little or no conflict between operation for legacy WD 22s and new WD 22s, e.g., by preventing legacy WD 22s from accessing a cell which supports channel BWs of less than 5 MHz (e.g., 3 MHz channel bandwidth).

In some embodiments the interpretation for cellBarred and/or intraFrequencyReselection fields in MIB are given in the following:
A Legacy WD 22 can be barred (e.g., configured based on coexistence configuration information received from a network node 16 and/or preconfigured in memory 54 to restrict) from accessing the cell with channel BW of less than 5 MHz by setting the cellBarred field to value ‘barred’ in MIB;
When the cellBarred is set to value ‘barred’ the intraFrequencyReselection field may be set to value ‘notAllowed’ to indicate that the legacy WD 22 is not allowed (e.g., configured based on coexistence configuration information received from a network node 16 and/or preconfigured in memory 54 to be restricted) to reselect to another cell on the same frequency;
New WD 22 supporting channel BW of less than 5 MHz will ignore (e.g., based on coexistence configuration information received from a network node 16 and/or preconfigured in memory 54) the cellBarred field in MIB; and
New WD 22 supporting channel BW of less than 5 MHz will ignore (e.g., configured based on coexistence configuration information received from a network node 16 and/or preconfigured in memory 54) the intraFrequencyReselection field in MIB.

In some embodiments, when the WD 22 is to be configured with the LessThan5MHzFR1 feature or when WD 22 supports channel BW less than 5 MHz, the cellBarred field in MIB may by default be set to ‘barred’.

In some embodiments, a new WD 22 intended to operate in an NR channel BW of less than 5 MHz (e.g., 3 MHz) omits (e.g., based on coexistence configuration information received from a network node 16 and/or preconfigured in memory 54) the cellBarred field in MIB assuming by default the WD 22 is not barred and hence is allowed to camp on the cell 18.

In one dependent embodiment, a legacy WD 22 intended to operate in an NR channel BW of less than 5 MHz (e.g., 3 MHz) decodes (e.g., based on coexistence configuration information received from a network node 16 and/or preconfigured in memory 54) the cellBarred field in MIB and upon determining the field indicates ‘barred’, and the WD 22 is configured to abandon its intention to camp on the cell 18, since it is not allowed to operate in it.

In embodiments of the present disclosure, an example term is used, “LessThan5MHzFR1”, to name a feature associated with the support of NR channel BW of less than 5 MHz (e.g., 3 MHz). However, embodiments may be applicable to any other terminology, e.g., as eventually specified in 3GPP technical specifications.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

### EMBODIMENTS

Embodiment A1. A network node configured to communicate with a wireless device (WD) in a wireless communication network supporting at least one high bandwidth sync raster and at least one low bandwidth sync raster, the network node configured to, and/or comprising a radio interface and/or comprising processing circuitry configured to:
determine a coexistence configuration comprising coexistence configuration information;
cause transmission of the coexistence configuration to the WD for processing of synchronization signaling; and
cause transmission of the synchronization signaling based on the coexistence configuration information, the synchronization signaling being transmitted on a channel bandwidth associated with a low bandwidth sync raster.

Embodiment A2. The network node of Embodiment A1, wherein the high bandwidth sync raster is associated with bandwidths at or above 5 MHz, and the low bandwidth sync raster is associated with bandwidths below 5 MHz.

Embodiment A3. The network node of Embodiment A1, wherein the low bandwidth sync raster is overlapping with a legacy sync raster; and
the processing circuitry being further configured to:
   determine a frequency offset to the overlapping sync raster entries based on the coexistence configuration information; and
   cause transmission and/or configure the synchronization signaling by applying the frequency offset to the legacy sync raster.

Embodiment B1. A method implemented in a network node that is configured to communicate with a wireless device in a wireless communication network supporting at least one high bandwidth sync raster and at least one low bandwidth sync raster, the method comprising:
determining a coexistence configuration comprising coexistence configuration information;
transmitting the coexistence configuration to the WD for processing of synchronization signaling;
transmitting the synchronization signaling based on the coexistence configuration information, the synchronization signaling being transmitted on a channel bandwidth associated with a low bandwidth sync raster.

Embodiment B2. The method of Embodiment B1, wherein the high bandwidth sync raster is associated with bandwidths at or above 5 MHz, and the low bandwidth sync raster is associated with bandwidths below 5 MHz.

Embodiment B3. The method of Embodiment B1, wherein the low bandwidth sync raster is overlapping with a legacy sync raster; and
the method further comprising:
   determining a frequency offset to the overlapping sync raster entries based on the coexistence configuration information; and
   causing transmission and/or configuring the synchronization signaling by applying the frequency offset to the legacy sync raster.

Embodiment C1. A wireless device (WD) configured to communicate with a network node in a wireless communication network supporting at least one high bandwidth sync raster and at least one low bandwidth sync raster, the WD configured to, and/or comprising a radio interface and/or processing circuitry configured to:
receive and/or store coexistence configuration information;
receive synchronization signaling from the network node; and
process the synchronization signaling based on the coexistence configuration information, the synchronization signaling being received on a channel bandwidth associated with a low bandwidth sync raster.

Embodiment C2. The WD of Embodiment C1, wherein the high bandwidth sync raster is associated with bandwidths at or above 5 MHz, and the low bandwidth sync raster is associated with bandwidths below 5 MHz.

Embodiment C3. The WD of Embodiment C1, wherein the low bandwidth sync raster is overlapping with a legacy sync raster; and
the processing circuitry being further configured to:
   determine a frequency offset to the overlapping sync raster entries based on the coexistence configuration information; and
   process the synchronization signaling by applying the frequency offset to the legacy sync raster.

Embodiment D1. A method implemented in a wireless device (WD) that is configured to communicate with a network node in a wireless communication network supporting at least one high bandwidth sync raster and at least one low bandwidth sync raster, the method comprising:
receiving and/or storing coexistence configuration information;
receiving synchronization signaling from the network node; and
processing the synchronization signaling based on the coexistence configuration information, the synchronization signaling being received on a channel bandwidth associated with the low bandwidth sync raster.

Embodiment D2. The method of Embodiment D1, wherein the high bandwidth sync raster is associated with bandwidths at or above 5 MHz, and the low bandwidth sync raster is associated with bandwidths below 5 MHz.

Embodiment D3. The method of Embodiment D1, wherein the low bandwidth sync raster is overlapping with a legacy sync raster; and
the method further comprising:
   determining a frequency offset to the overlapping sync raster entries based on the coexistence configuration information; and
   processing the synchronization signaling by applying the frequency offset to the legacy sync raster.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:
3GPP Third Generation Partnership Project
BW Bandwidth
FDD Frequency Division Duplex
FFS For Further Study
FRMCS Future Railway Mobile Communication System
FR1/FR2 Frequency Range 1/Frequency Range 2
MIB Master Information Block
NR New radio
RAN Radio Access Network
RB Resource Block
PBCH Physical Broadcast Channel
PSS Primary Synchronization Signal
SCS Subcarrier spacing
SSS Secondary Synchronization Signal
SSB Synchronization Signal Block (SS/PBCH block)
TS Technical Specification
UE User Equipment
WI Work Item
WID Work Item Description

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings.

1. A wireless device, WD, capable of supporting channel bandwidth of both less than 5 MHz and at or above than 5 MHz, the WD being configurable to communicate with a network node in a wireless communication network operating in a frequency band supporting both a channel bandwidth less than 5 MHz and a channel bandwidth at or above 5 MHz, the WD being configured to:
obtain a synchronization raster for the channel bandwidth less than 5 MHz supported by an operating band;
obtain a synchronization raster for the channel bandwidth at or above 5 MHz supported by the same operating band, the synchronization raster for the channel bandwidth less than 5 MHz having a frequency offset to and a finer granularity than the synchronization raster for the channel bandwidth at or above 5 MHz;
perform cell search on at least one of the synchronization rasters to attempt to receive synchronization signaling from the network node; and
process received synchronization signaling.

2. (canceled)

3. (canceled)

4. The WD of claim 1, wherein when receiving the synchronization signaling on the synchronization raster for the channel bandwidth less than 5 MHz, the WD is configured to receive the synchronization signaling with a punctured structure.

5. The WD of claim 1, wherein the WD is configured to obtain the synchronization raster for the channel bandwidth less than 5 MHz supported by the operating band by obtaining preconfigured configuration information in the WD.

6. A method performed in a wireless device, WD, to communicate with a network node in a wireless communication network operating in a frequency band supporting both a channel bandwidth less than 5 MHz and a channel bandwidth at or above 5 MHz, the WD being capable of supporting channel bandwidth of both less than 5 MHz and at or above than 5 MHz, the method comprising:
obtaining a synchronization raster for the channel bandwidth less than 5 MHz supported by the operating band;
obtaining a synchronization raster for the channel bandwidth at or above 5 MHz supported by the same operating band, wherein the synchronization raster for the channel bandwidth less than 5 MHz has a frequency offset to and a finer granularity than the synchronization raster for the channel bandwidth at or above 5 MHz;
performing cell search on at least one of the synchronization rasters to attempt to receive synchronization from the network node; and
processing received synchronization signaling.

7. The method of claim 6, wherein the receiving synchronization signaling on the synchronization raster for the channel bandwidth less than 5 MHz comprises:
receiving the synchronization signaling with a punctured structure from the network node.

8. The method of claim 6, wherein obtaining the synchronization rasters for the channel bandwidth less than 5 MHz and for channel bandwidth at or above 5 MHz comprises obtaining the synchronization rasters from preconfigured configuration information in the WD.

9. (canceled)

10. (canceled)

11. A method performed in a network node operating in a frequency band supporting both a channel bandwidth less than 5 MHz and a channel bandwidth at or above 5 MHz, the method comprising:
obtaining a synchronization raster for a channel bandwidth less than 5 MHz supported by the operating band and a synchronization raster for channel bandwidth at or above than 5 MHz supported by the same operating band, the synchronization raster for the channel bandwidth less than 5 MHz having a frequency offset to and a finer granularity than the synchronization raster for the channel bandwidth at or above 5 MHz; and
transmitting synchronization signalings based on respective synchronization rasters in the operating band.

12. The method of claim 11, wherein transmitting synchronization signaling based on the synchronization raster for the channel bandwidth less than 5 MHz comprises: transmitting synchronization signaling with a punctured structure.

13. (canceled)

14. A network node operating in a frequency band supporting both a channel bandwidth less than 5 MHz and a channel bandwidth at or above 5 MHz, the network node configured to, and/or comprising a radio interface and/or comprising processing circuitry configured to:
obtain a synchronization raster for a channel bandwidth less than 5 MHz supported by the operating band and a synchronization raster for a channel bandwidth at or above than 5 MHz supported by the same operating band, the synchronization raster for the channel bandwidth less than 5 MHz having a frequency offset to and a finer granularity than the synchronization raster for the channel bandwidth at or above 5 MHz; and
transmit synchronization signalings based on respective synchronization rasters in the operating band.

15. The network node of claim 14, wherein when transmitting synchronization signaling based on the synchronization raster for the channel bandwidth less than 5 MHz, the network node is configured to transmit the synchronization signaling with a punctured structure.

16. The WD of claim 4, wherein the WD is configured to obtain the synchronization raster for the channel bandwidth less than 5 MHz supported by the operating band by obtaining preconfigured configuration information in the WD.

17. The method of claim 7, wherein the synchronization signaling with the punctured structure comprises a smaller number of resource blocks than that of synchronization signaling transmitted by the network node on the synchronization raster for the channel bandwidth at or above 5 MHz

18. The method of claim 12, wherein the synchronization signaling with the punctured structure comprises a smaller number of resource blocks than that of the synchronization signaling transmitted on the synchronization raster for the channel bandwidth at or above 5 MHz.

19. The network node of claim 15, wherein the synchronization signaling with the punctured structure comprises a smaller number of resource blocks than that of the synchronization signaling transmitted on the synchronization raster for the channel bandwidth at or above 5 MHz.
